(19) United States
(12) Patent Application Publication
(10) Pub. No.: US 2025/0201974 A1
(43) Pub. Date: Jun. 19, 2025

(54) BATTERY CELL AND ANODE

(71) Applicant: Toyota Jidosha Kabushiki Kaisha, Toyota-shi (JP)

(72) Inventors: Tomoya MESUDA, Nisshin-shi (JP); Seigo FUJISHIMA, Miyoshi-shi (JP); Yoshiro OBAYASHI, Toyota-shi (JP); Kosuke SUZUKI, Toyota-shi (JP); Takeru HARA, Toyota-shi (JP); Satoshi MORIYAMA, Nagoya-shi (JP); Kenta MIYAHARA, Toyohashi-shi (JP)

(73) Assignee: Toyota Jidosha Kabushiki Kaisha, Toyota-shi (JP)

(21) Appl. No.: 18/965,124

(22) Filed: Dec. 2, 2024

(30) Foreign Application Priority Data
Dec. 14, 2023 (JP) 2023-211484

(51) Int. Cl. H01M 50/105; B60L 50/64; H01M 4/02; H01M 4/38

(52) U.S. Cl. CPC H01M 50/105; H01M 4/386; B60L 50/64; H01M 2004/027; H01M 2220/20

(57) ABSTRACT

The battery cell includes an electrode body formed by laminating a cathode, an anode, and a separator, and a laminate film that seals the electrode body in a state in which the electrode body is accommodated, and the anode includes a current collector coated with an anode composite material containing an anode active material, and the anode active material contained in the anode composite material is smaller in the middle portion than in the end portion.

### CROSS-REFERENCE TO RELATED APPLICATION

This application claims priority to Japanese Patent Application No. 2023-211484 filed on Dec. 14, 2023, incorporated herein by reference in its entirety.

### BACKGROUND

### 1. Technical Field

The disclosure relates to a battery cell and an anode.

### 2. Description of Related Art

US 2018/287184 A discloses a battery module in which an electrode assembly is accommodated in a case. Also, a structure thereof is one in which outside of the electrode assembly (battery cell) is surrounded by a heat-shrinkable protective layer to suppress thermal expansion of the electrode assembly.

### SUMMARY

However, in the structure according to US 2018/287184 A, there is a need to prepare the dedicated heat-shrinkable protective layer in order to suppress thermal expansion, which may increase manufacturing costs and man-hours.

In view of the above, an object of the disclosure is to provide a battery cell and an anode capable of suppressing thermal expansion with a simple structure.

A battery cell according to a first aspect includes an electrode body, in which a cathode, an anode, and a separator are laminated, and a laminate film for sealing the electrode body in an accommodated state, in which the anode includes a current collector that is coated with an anode composite material containing an anode active material, and an amount of the anode active material contained in the anode composite material is smaller at a middle portion of the anode than at an end portion.

In the battery cell according to the first aspect, the electrode body is formed by laminating the cathode, the anode, and the separator. Also, the electrode body is sealed with the laminate film. Now, the anode is configured including the current collector coated with the anode composite material containing the anode active material, and the anode active material contained in the anode composite material is smaller at the middle portion of the anode than at the end portion thereof. Accordingly, the thermal expansion can be suppressed particularly with respect to the middle portion of the anode in which change in volume due to thermal expansion is greater. Also, there is no need to separately prepare a member for suppressing thermal expansion. Note that the terms “end portion” and “middle portion” here are not limited to end portions and central portions in a plurality of directions, and are concepts broadly including end portions and middle portions in one direction. Also, the term “anode composite material” as used herein refers to an admixture material containing the anode active material, a binder, and a conductive aid.

The battery cell according to a second aspect, wherein in the first aspect, a density of the anode active material contained in the anode composite material is lower at the middle portion of the anode than at the end portion.

In the battery cell according to the second aspect, thermal expansion of the battery cell is suppressed by changing the density of the anode active material contained in the anode composite material at the middle portion of the anode and the end portion thereof. Thus, thickness of the anode active material can be made to be the same at the middle portion and the end portion.

In the battery cell according to a third aspect, in the first aspect, a thickness of the anode composite material is smaller at the middle portion of the anode than at the end portion.

In the battery cell according to the third aspect, thermal expansion of the battery cell is suppressed by making the thickness of the anode composite material smaller at the middle portion of the anode than at the end portion thereof. Thus, the thermal expansion of the battery cell can be suppressed simply by reducing the anode composite material at the middle portion of the anode.

In the battery cell according to a fourth aspect in any one of the first to third aspects, the anode active material contains elemental silicon.

In the battery cell according to the fourth aspect, the anode active material is configured containing elemental silicon. While elemental silicon is particularly excellent in terms of specific capacity, the change in volume is great, but the thermal expansion of the battery cell can be effectively suppressed by reducing the anode active material at the middle portion as compared to the end portion.

The anode according to a fifth aspect is an anode that makes up an electrode body together with a cathode and a separator, the anode including a current collector, and an anode composite material containing an anode active material that is coated on the current collector, in which an amount of the anode active material contained in the anode composite material is smaller at a middle portion of the anode than at an end portion.

The anode according to the fifth aspect includes the current collector and the anode composite material, and the amount of anode active material contained in the anode composite material at the middle portion of the anode is smaller than at the end portion thereof. Accordingly, the thermal expansion can be suppressed particularly with respect to the middle portion of the anode in which change in volume due to thermal expansion is greater.

As described above, according to the battery cell and the anode of the disclosure, thermal expansion can be suppressed with a simple structure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view illustrating a main part of a vehicle to which a battery pack including a battery cell according to an embodiment is applied;

FIG. 2 is a schematic perspective view of a battery module accommodating battery cells according to an embodiment;

FIG. 3 is a plan view of the battery module with an upper lid removed;

FIG. 4 is a schematic view of a battery cell according to an embodiment as viewed from a thickness direction;

FIG. 5 is a schematic view of an anode constituting a battery cell according to an embodiment as viewed from a thickness direction; and

FIG. 6 is a schematic view of an anode constituting a battery cell according to a modification viewed from a thickness direction.

### DETAILED DESCRIPTION OF EMBODIMENTS

The battery module 11 including the battery cell 20 according to the embodiment will be described with reference to the drawings.

### Overall Configuration of Vehicle 100

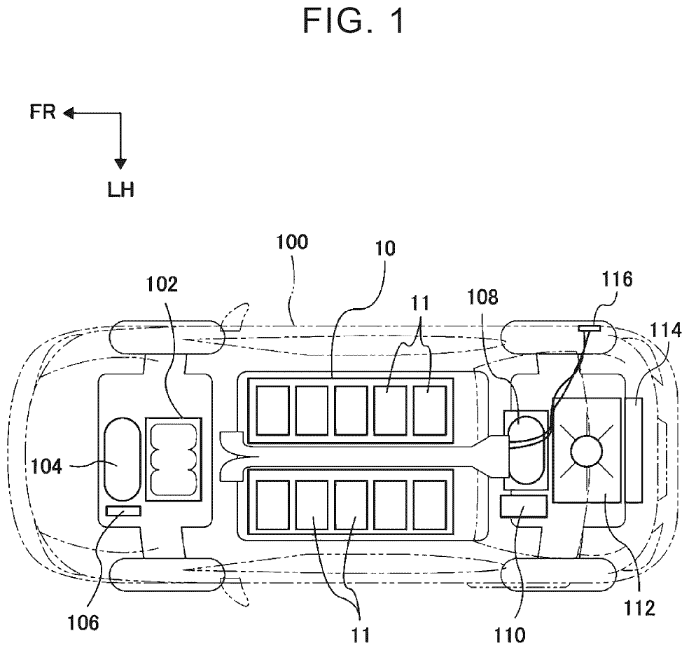

FIG. 1 is a schematic plan view showing a main part of a vehicle 100 to which a battery pack 10 having a battery module 11 according to the present embodiment is applied. As illustrated in FIG. 1, the vehicle 100 is a battery electric vehicle (BEV) in which the battery pack 10 is mounted under the floor. Note that the arrows UP, the arrow FR, and the arrow LH in the drawings respectively indicate the upper side in the vehicle up-down direction, the front side in the vehicle front-rear direction, and the left side in the vehicle widthwise direction. In the case where the description is made using the front, rear, left, right, and up and down directions, the front and back directions in the vehicle front-rear direction, the left and right directions in the vehicle width direction, and the up and down directions in the vehicle vertical direction are shown unless otherwise specified.

In the vehicle 100 of the present embodiment, DC/DC converters 102, the electric compressor 104, and PTC (Positive Temperature Coefficient) heaters 106 are arranged in front of the vehicle relative to the battery pack 10. Further, a motor 108, a gear box 110, an inverter 112, and a charger 114 are disposed on the vehicle rear side of the battery pack 10.

The DC current outputted from the battery pack 10 is regulated by DC/DC converters 102 and then supplied to the electric compressor 104, PTC heaters 106, the inverter 112, and the like. Further, electric power is supplied to the motor 108 via the inverter 112, so that the rear wheels rotate to drive the vehicle 100.

A charging port 116 is provided on the right side portion of the rear portion of the vehicle 100, and electric power can be stored in the battery pack 10 via the in-vehicle charger 114 by connecting a charging plug of an external charging facility (not shown) from the charging port 116.

Note that the arrangement, structure, and the like of the components constituting the vehicle 100 are not limited to the above-described configurations. For example, it may be applied to an engine-mounted hybrid electric vehicle (HV) or plug-in hybrid electric vehicle (PHEV). Further, in the present embodiment, the motor 108 is a rear-wheel-driven vehicle mounted on the vehicle rear portion, but the present disclosure is not limited thereto, and the motor 108 may be a front-wheel-driven vehicle mounted on the vehicle front portion, or a pair of motors 108 may be mounted on the vehicle front and rear. Further, the vehicle may be provided with an in-wheel motor for each wheel.

Here, the battery pack 10 includes a plurality of battery modules 11. In the present embodiment, as an example, ten battery modules 11 are provided. Specifically, five battery modules 11 are arranged in the vehicle front-rear direction on the right side of the vehicle 100, and five battery modules 11 are arranged in the vehicle front-rear direction on the left side of the vehicle 100. The battery modules 11 are electrically connected to each other.

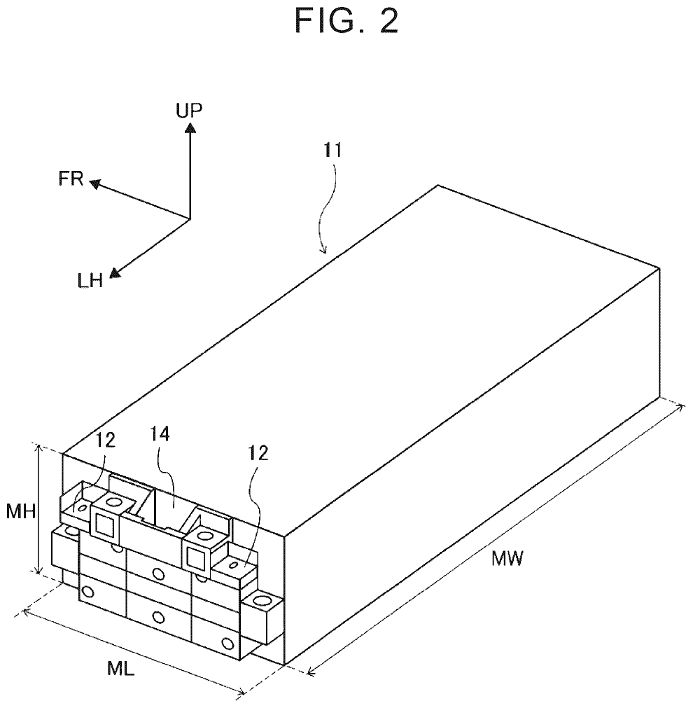

FIG. 2 is a schematic perspective view of the battery module 11. As shown in FIG. 2, the battery module 11 is formed in a substantially rectangular parallelepiped shape whose longitudinal direction is the vehicle width direction. The case 13 of the battery module 11 is made of an aluminum alloy. For example, the case 13 of the battery module 11 is formed by joining aluminum die-casting to both ends of an extruded material of an aluminum alloy by laser welding or the like.

A pair of voltage terminals 12 and a connector 14 are provided at both end portions of the battery module 11 in the vehicle width direction, respectively. A flexible printed circuit board 21, which will be described later, is connected to the connector 14. A bus bar (not shown) is welded to both end portions of the battery module 11 in the vehicle width direction.

The length MW of the battery module 11 in the vehicle width direction is, for example, 350 mm to 600 mm, the length ML in the vehicle front-rear direction is, for example, 150 mm to 250 mm, and the height MH in the vehicle vertical direction is, for example, 80 mm to 110 mm.

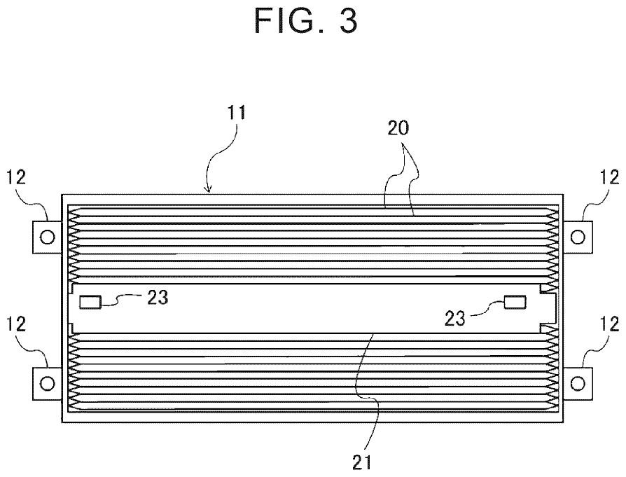

FIG. 3 is a plan view of the battery module 11 with the upper lid removed. As shown in FIG. 3, a battery cell group in which a plurality of battery cells 20 are arranged is accommodated in the battery module 11. In the present embodiment, as an example, 24 battery cells 20 are arranged in the vehicle front-rear direction and adhered to each other.

A flexible printed circuit board (FPC: Flexible Printed Circuit) 21 is disposed on the battery cell 20. The flexible printed circuit board 21 is formed in a band shape with the vehicle width direction as a longitudinal direction, and thermistors 23 are provided at both end portions of the flexible printed circuit board 21. The thermistor 23 is not adhered to the battery cell 20 and is pressed toward the battery cell 20 by the upper lid of the battery module 11.

One or a plurality of buffer plates (not shown) are accommodated in the battery module 11. For example, the buffer plate is an elastically deformable thin plate-shaped member, and is disposed between the adjacent battery cells 20 with the arrangement direction of the battery cells 20 as the thickness direction. In the present embodiment, as an example, cushioning materials are disposed at both end portions in the longitudinal direction of the battery module 11 and at a middle portion in the longitudinal direction, respectively.

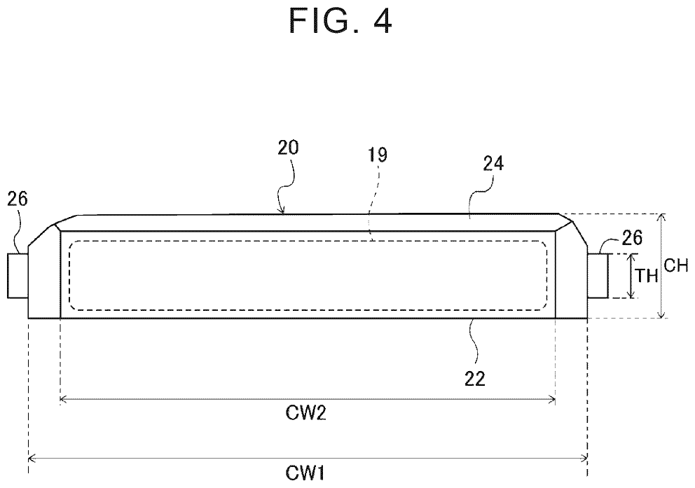

FIG. 4 is a schematic view of the battery cell 20 accommodated in the battery module 11 as viewed from the thickness direction. As shown in FIG. 4, the battery cell 20 is formed in a substantially rectangular plate shape, and an elongated electrode body 19 is accommodated therein. The electrode body 19 is formed by laminating a cathode, an anode, and a separator, and is sealed with a laminate film 22.

In the present embodiment, as an example, the embossed sheet-like laminate film 22 is folded and bonded to form a housing portion of the electrode body 19. It is to be noted that although both of the single-cup embossed structure in which the embossing is performed at one place and the double-cup embossed structure in which the embossing is performed at two places can be adopted, in the present embodiment, the single-cup embossed structure has a drawing depth of about 8 mm to 10 mm.

The upper ends of both end portions in the longitudinal direction of the battery cell 20 are bent, and the corners have an outer shape. Further, the upper end portion of the battery cell 20 is bent, and the fixing tape 24 is wound around the upper end portion of the battery cell 20 along the longitudinal direction.

Here, terminals (tabs) 26 are provided at both ends in the longitudinal direction of the battery cell 20. In the present embodiment, as an example, the terminal 26 is provided at a position offset downward from the center of the battery cell 20 in the vertical direction. The terminal 26 is joined to a bus bar (not shown) by laser welding or the like.

The vehicle-width-direction length CW1 of the battery cells 20 is, for example, 530 mm to 600 mm. The length CW2 of the area in which the electrode body 19 is accommodated is, for example, 500 mm to 520 mm. The height CH of the battery cell 20 is, for example, 80 mm to 110 mm. Therefore, the battery cell 20 is formed in an elongated shape, and the length CW1 and the direction of CW2 are the longitudinal direction.

The thickness of the battery cell 20 is 7.0 mm to 9.0 mm, and the height TH of the terminal 26 is 40 mm to 50 mm.

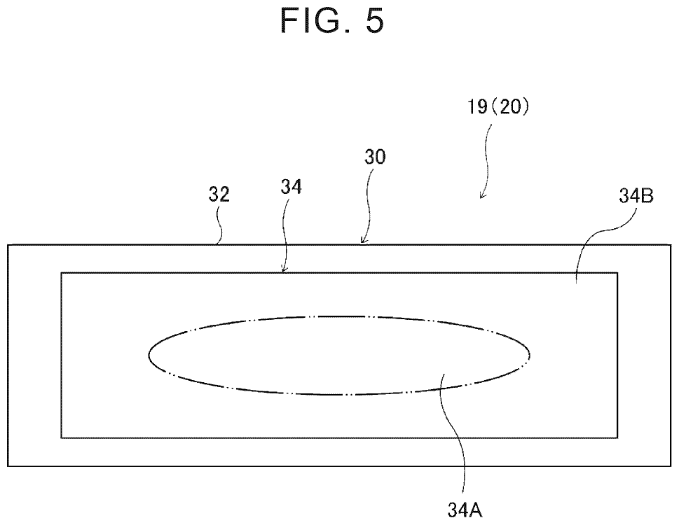

FIG. 5 is a schematic view of the anode 30 constituting the battery cell 20 according to the embodiment as viewed from the thickness direction. As shown in FIG. 5, the anode 30 includes a current collector 32 and an anode active material 34 applied to the surface of the current collector 32.

The current collector 32 is formed of a metal foil, and is formed of, for example, a copper foil in a substantially rectangular sheet shape. The anode active material 34 held by the current collector 32 constitutes an anode composite material together with a binder and a conductive auxiliary agent, and absorbs lithium ions, which are charge carriers, from the non-aqueous electrolytic solution and releases them to the non-aqueous electrolytic solution in accordance with charging and discharging. The anode active material 34 of the present embodiment is made of a material containing a silicon element such as porous silicon or a silicon-based carbon composite material, but is not limited thereto. For example, a known anode active material such as artificial graphite or lithium-alloy (LiXM) may be used as the anode active material. In LiXM, Mis C, Si, Sn, Sb, Al, Mg, Ti, Bi, Ge, Pb, P, or the like, and X is a natural number. The anode active material layer formed of the anode active material 34 may contain a known binder such as a styrene-butadiene copolymer.

The cathode constituting the electrode body 19 includes a current collector formed of an aluminum foil or the like and a cathode active material. The cathode active material releases lithium ions into or occludes from the non-aqueous electrolyte. As the cathode active material, a known cathode active material such as LiNiO2, LiNi1/3Co1/3Mn1/3O2 is used. Further, carbon black, trilithium phosphate and a known binder may be further contained.

The separator is a sheet-like member that electrically insulates the cathode and the anode 30 and provides a movement path of lithium ions between the cathode active material and the anode active material 34. Examples of the separator include a porous film formed of polyethylene, polypropylene, and the like. The separator may have a single-layer structure or a multi-layer structure.

Here, in the present embodiment, the anode active material 34 is provided in a portion excluding the peripheral end portion of the current collector 32, and is coated in a substantially rectangular shape when viewed in the thickness direction. In addition, the middle portion 34A of the anode active material 34 included in the anode composite material is smaller than the end portion 34B.

Specifically, the anode active material 34 included in the anode composite material of the present embodiment has a lower density in the middle portion 34A than the end portion 34B. In other words, the basis weight of the middle portion 34A is smaller than that of the end portion 34B. For example, when the anode active material 34 is pressed, the pressing pressure on the middle portion 34A may be made smaller than that on the end portion 34B, so that the density of the middle portion 34A may be relatively low. Alternatively, two types of anode active materials 34 having different densities may be prepared in advance, and the anode active material 34 having a lower density may be disposed on the middle portion 34A.

In the present embodiment, the lower-density middle portion 34A of the anode active material 34 is an area surrounded by a two-dot chain line in the drawing. That is, it is a middle portion in the longitudinal direction of the anode 30 and a middle portion in the lateral direction of the anode 30.

On the other hand, the end portion in the longitudinal direction of the anode 30 and the end portion in the lateral direction of the anode 30 have a relatively high-density end portion 34B of the anode active material 34.

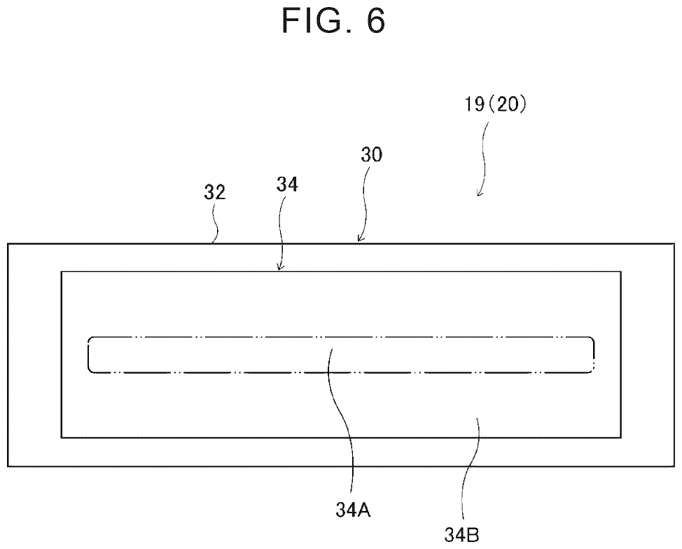

Note that the configuration is not limited to the configuration of FIG. 5, and the structure of the modified example illustrated in FIG. 6 may be adopted.

FIG. 6 is a schematic view of the anode constituting the battery cell 20 according to the modification viewed from the thickness direction. As shown in FIG. 6, in the battery cell 20 of the present modification, the anode active material 34 is provided in a portion excluding the end portion of the current collector 32, and is applied in a substantially rectangular shape when viewed in the thickness direction. In addition, the lateral middle portion 34A of the anode active material 34 is smaller than the end portion 34B.

### Action

Next, the operation of the battery cell 20 according to the present embodiment will be described.

As shown in FIG. 4, the battery cell 20 according to the present embodiment is formed in an elongated shape by sealing the electrode body 19 with the laminate film 22.

Further, as shown in FIG. 5, the anode 30 includes a current collector 32 coated with an anode composite material containing the anode active material 34, and the anode active material 34 contained in the anode composite material is smaller in the middle portion 34A than in the end portion 34B of the anode 30. Accordingly, the thermal expansion can be suppressed particularly with respect to the middle portion 34A of the anode 30 in which the volume change due to the thermal expansion increases. Also, there is no need to separately prepare a member for suppressing thermal expansion. As a result, thermal expansion of the battery cell 20 can be suppressed with a simple structure.

Further, in the present embodiment, the thermal expansion of the battery cell 20 is suppressed by changing the density of the anode active material 34 between the middle portion 34A and the end portion 34B of the anode 30. As a result, the thickness of the anode active material 34 can be made the same in the middle portion 34A and the end portion 34B.

In particular, the anode active material 34 of the present embodiment includes a silicon element. While the silicon element is excellent in particular in terms of specific capacitance, the volume change is large, but the thermal expansion of the battery cell 20 can be effectively suppressed by reducing the silicon in the middle portion 34A as compared with the end portion 34B as in the present embodiment.

Although the battery cell 20 and the anode 30 according to the embodiment have been described above, it is needless to say that the present disclosure is not limited thereto and can be implemented in various forms without departing from the gist of the present disclosure. In the above-described embodiment, as shown in FIG. 5, the density of the middle portion 34A of the anode active material 34 included in the anode composite material is lower than that of the end portion 34B. However, it is not limited thereto. Other structures may be employed as long as the anode active material 34 on the middle portion 34A is smaller than the end portion 34B. For example, the middle portion 34A of the anode active material 34 may be formed to be thinner than the end portion 34B. As a method of reducing the thickness of the middle portion 34A of the anode active material 34, a method may be used in which the anode active material 34 is applied and pressed in a normal manner, and then only the middle portion 34A is partially scraped off the anode active material 34.

The thermal expansion of the battery cell 20 is suppressed by making the middle portion 34A of the anode active material 34 thinner than the end portion 34B. Thus, the thermal expansion of the battery cell 20 can be suppressed only by reducing the anode active material 34 in the middle portion of the anode 30.

In addition, the middle portion 34A of the anode active material 34 may be made thinner than the end portion 34B, and the density of the middle portion 34A of the anode active material 34 may be made lower than the end portion 34B. Further, the concentration of silicon contained in the anode active material may be changed without changing the density of the anode active material. That is, even if the concentration of silicon in the middle portion of the anode active material is lower than the concentration of silicon in the end portion, the same effect can be obtained.

Further, in the above embodiment, the middle portion 34A having a low density of the anode active material 34 and the end portion 34B having a high density are formed with the two-dot chain line in FIG. 5 as a border, but the present disclosure is not limited thereto. For example, the density of the anode active material 34 may be changed stepwise from the end portion 34B toward the middle portion 34A, or the density of the anode active material 34 may be changed continuously from the end portion 34B toward the middle portion 34A.

With respect to the above embodiments, the following supplementary notes are disclosed.

### Appendix 1

A battery cell including an electrode body in which a cathode, an anode, and a separator are laminated, and a laminate film for sealing in a state of containing the electrode body. The anode includes a current collector coated with an anode composite material containing an anode active material, and the anode active material contained in the anode composite material in the middle portion is less than the end portion.

### Appendix 2

The battery cell according to appendix 1, wherein a density of the anode active material contained in the anode composite material is lower in a middle portion of the anode than in an end portion.

### Appendix 3

The battery cell according to appendix 1 or 2, wherein a thickness of the anode composite material is smaller in a middle portion of the anode than in an end portion.

### Appendix 4

The battery cell according to any one of Appendices 1 to 3, wherein the anode active material contains a silicon element.

### Appendix 5

An anode constituting an electrode body together with a cathode and a separator, the anode including a current collector, and an anode composite material containing an anode active material that is coated on the current collector, in which the anode active material contained in the anode composite material is less in the middle portion than the end portion.

What is claimed is:

1. A battery cell comprising:
an electrode body, in which a cathode, an anode, and a separator are laminated; and
a laminate film for sealing the electrode body in an accommodated state, wherein
the anode includes a current collector that is coated with an anode composite material containing an anode active material, and an amount of the anode active material contained in the anode composite material is smaller at a middle portion of the anode than at an end portion.

2. The battery cell according to claim 1, wherein a density of the anode active material contained in the anode composite material is lower at the middle portion of the anode than at the end portion.

3. The battery cell according to claim 1, wherein a thickness of the anode composite material is smaller at the middle portion of the anode than at the end portion.

4. The battery cell according to claim 1, wherein the anode active material contains elemental silicon.

5. An anode that makes up an electrode body together with a cathode and a separator, the anode comprising:
a current collector; and
an anode composite material containing an anode active material that is coated on the current collector, wherein
an amount of the anode active material contained in the anode composite material is smaller at a middle portion of the anode than at an end portion.
